(19) United States
(12) Patent Application Publication
(10) Pub. No.: US 2017/0192396 A1
(43) Pub. Date: Jul. 6, 2017

(54) ARM-WEARABLE DEVICE AND ANTENNA BODY

(71) Applicant: Seiko Epson Corporation, Tokyo (JP)

(72) Inventor: Jun MATSUZAKI, Shiojiri (JP)

(21) Appl. No.: 15/392,152

(22) Filed: Dec. 28, 2016

(30) Foreign Application Priority Data
Jan. 4, 2016 (JP) 2016-000246

(51) Int. Cl. G04R 20/02; H04B 1/16; G04R 60/06; H04B 1/08

(52) U.S. Cl. CPC G04R 20/02; H04B 1/086; H04B 1/1607; G04R 60/06

(57) ABSTRACT

An electronic timepiece includes a case body, a dial plate that is accommodated in the case body so as to display a time, and an annular antenna body that is disposed around the dial plate. The antenna body has an annular base member formed in a dielectric body, and an electrically conductive power feeding element which has a band shape and to which a predetermined potential is fed from a power feeding unit, and a second electrically conductive power feeding element which has a band shape and to which a predetermined potential is fed from a power feeding unit.

### BACKGROUND

1. Technical Field

The present invention relates to an arm-wearable device having an incorporated antenna, and an antenna body incorporated in the arm-wearable device.

2. Related Art

In general, an arm-wearable device having an incorporated antenna includes a one-to-one antenna for a radio wave to be received, in accordance with a receiving frequency or a wireless system. In order to ensure receiver sensitivity and ensure dial design, a ring antenna for global positioning system (GPS) solar communication is disposed (for example, refer to JP-A-2014-62844).

In JP-A-2014-62844, an annular antenna body is disposed around a dial accommodated in an exterior case so as to supply power from a power feeding unit to the antenna body. The antenna body has an annular base member formed in a dielectric body, and an arcuate power feeding element to which the power is fed from the power feeding unit. The antenna body receives a circular polarized wave in such a way that an annular passive element is disposed between a dial ring and a cover glass. The arcuate power feeding element described in JP-A-2014-62844 is provided in a one-to-one relationship so as to correspond to one GPS frequency.

Incidentally, in recent years, short-range wireless communication such as Bluetooth® is used for an arm-wearable device in some cases. Receivable frequencies or wireless systems have increased, and thus, the arm-wearable device tends to become multifunctional. However, according to the arm-wearable device described in JP-A-2014-62844, it is necessary to add a 2.4GHz band chip antenna for the short-range wireless communication, for example, apart from the ring antenna for receiving a GPS signal.

However, in a case where multiple rings for the antenna are provided for each frequency or each wireless system, or when the multiple rings are stacked on one another, the thickness increases correspondingly, thereby resulting in poor receiver sensitivity of the antenna disposed below. On the other hand, in order to dispose the multiple rings so as not to overlap each other, the multiple rings has to be disposed concentrically, and a display region such as a dial is narrowed by the rings, thereby resulting in poor visibility and design.

On the other hand, a chip itself needs to be mounted on a circuit board. Accordingly, in order to ensure design, a chip antenna has to be disposed below the dial. Consequently, the receiver sensitivity becomes poor due to the dial. On the other hand, if the chip antenna is disposed on a top surface of the dial in order to ensure sensitivity of the chip antenna, the design becomes poor.

### SUMMARY

An advantage of some aspects of the invention is to provide an arm-wearable device which can be multifunctional by increasing applicable frequencies and wireless systems, while both receiver sensitivity and visibility/design are ensured.

An arm-wearable device according to an aspect of the invention includes an exterior case, a time display unit that is accommodated in the exterior case, and that displays a time, and an annular antenna body that is disposed around the time display unit. The antenna body has an annular base member having a dielectric body, a first band-shaped power feeding element which is disposed in the base member, which is electrically conductive, and to which a predetermined potential is fed from a first power feeding unit, and a second band-shaped power feeding element which is disposed in the base member, which is electrically conductive, and to which a predetermined potential is fed from a second power feeding unit.

According to the above-described configuration, the first and second power feeding elements serving as at least two antennas are respectively disposed for each frequency or each wireless system of a radio wave to be received. The power feeding elements are caused to have a band shape (shape obtained by cutting a portion of an annular shape). In this manner, both of these can be disposed on the common annular base member. As a result, it is possible to avoid an increase in the number of base members. It is possible to avoid an increase in the thickness or a decreases in a display region in a case where multiple base members are provided. It is also possible to ensure visibility/design. A wireless IC chip can be disposed below apart from the antenna body in a direction of viewing the time display unit such as a dial via a power feeding pin from the power feeding unit. Therefore, it is possible to avoid poor design while receiver sensitivity is ensured.

For example, the “time display unit” in the aspect of the invention includes a form in which an indicating hand turns around an indicating hand axle as the center on the dial so as to indicate a time. In addition, for example, the “time display unit” includes a form in which a liquid-crystal display panel having a display region having a size corresponding to the dial is provided so as to display a time by displaying the dial or an image of the indicating hand on the display region, or a form in which a time is displayed on the liquid-crystal display panel in a digital manner. The “annular shape” may be a wheel whose entire body is connected without being cut. A shape of the wheel (ring) may be circular or elliptical. Alternatively, a shape thereof may be polygonal such as square. Furthermore, for example, the “power feeding element” may be formed on a surface of the dielectric body by means of plating or silver paste printing, or may be incorporated into the dielectric body by means of insert-molding.

In the arm-wearable device according to the aspect of the invention, in planar view of the annular base member in a vertical direction, the first power feeding element and the second power feeding element may be disposed at a position where both of these do not overlap each other. According to this configuration, it is possible to avoid receiver sensitivity of the power feeding element located below from becoming poor due to the first and second power feeding elements overlapping each other. Therefore, it is possible to more reliably ensure the receiver sensitivity.

For example, the meaning of “both of these do not overlap each other” in the aspect of the invention includes a state where the first and second power feeding elements are respectively disposed inside a semicircular arc bisected by a diameter passing through the center of the base member, when an angle formed between both ends of the respective power feeding elements is 180° or smaller at a center point of the annular base member in both the first and second power feeding elements in a case where two power feeding elements are provided (refer to FIGS. 7A and 7B).

In a case where two power feeding elements are provided, regardless of the angle formed between both ends of the power feeding elements, the two power feeding elements are disposed to face each other across the center of the base member on the diameter in which the center point of both ends of the power feeding elements passes through the center of the base member. In this manner, the two power feeding elements can be laterally symmetrical across the diameter (refer to FIGS. 7A and 7C). In this case, both ends are equally apart from each other to a maximum degree. Consequently, the respective center points of the power feeding elements are disposed to face each other across the center point of the base member. However, the invention is not limited thereto. If the first and second power feeding elements do not overlap each other, the two power feeding elements can be laterally asymmetrical across the diameter (refer to FIGS. 7B and 7D). Even in this case, when the angle formed between both ends of the respective power feeding elements is 180° or smaller, the first and second power feeding elements are respectively disposed inside the semicircular arc bisected by the diameter passing through the center of the base member (refer to FIG. 7B). Regardless of the angle formed between both ends of the power feeding elements, any one end portion of the other power feeding element is included in an arcuate region on the opposite side across the center point which is divided by two straight lines passing through the center of the base member from both ends of one power feeding element (refer to FIG. 7D).

In the arm-wearable device according to the aspect of the invention, an annular or a band-shaped passive element which is electrically conductive may be disposed in the base member, apart from the first power feeding element and the second power feeding element. The “passive element” in the aspect of the invention may maintain an insulated state apart from the first and second power feeding elements. For example, the “passive element” may be formed in another dielectric body separate from the base member, or may be formed together with the first and second power feeding elements on the base member. Similarly to the above-described power feeding element, for example, the “passive element” may be formed on the surface of the dielectric body by means of plating or silver paste printing, or may be incorporated into the dielectric body by means of insert-molding. According to this configuration, the power feeding element and the passive element are disposed apart from each other in the annular dielectric body.

In this case, if a current flows in the power feeding element, the current is also induced to the passive element. Accordingly, the power feeding element and the passive element are electromagnetically coupled to each other. Both of these are integrated, thereby functioning as an antenna element which converts an electromagnetic wave to a current. For example, in the power feeding element and the passive element which are disposed on the dielectric body, the length of the passive element is set to resonate with a receiving target radio wave. In this manner, the length of the power feeding element can be appropriately set. Therefore, it is possible to easily adjust impedance between the antenna body (the dielectric body and the power feeding element) and the passive element, and a circuit electrically connected to the antenna body. The passive element is electromagnetically coupled to the power feeding element. In this manner, it is possible to improve impedance characteristics by decreasing resonance frequencies of the antenna body. Accordingly, the resonance frequencies of the antenna body are caused to match a receiving target radio wave. In this manner, it is possible to improve receiving performance of the antenna body to receive the receiving target radio wave by reducing return loss in the resonance frequencies.

In the arm-wearable device according to the aspect of the invention, in planar view of the annular base member in a vertical direction, the first power feeding unit may be disposed inside a region of the first power feeding element, the second power feeding unit is disposed inside a region of the second power feeding element, and the first power feeding element and the second power feeding element are respectively disposed at a position where both of these do not overlap each other.

Similarly to the above-described power feeding element, for example, the “position where the first and second power feeding units do not overlap each other” in the aspect of the invention includes a state where the first and second power feeding units are respectively disposed inside the semicircular arc bisected by the diameter passing through the center of the base member. When the first and second power feeding units are apart from each other to a maximum degree in a case where two power feeding elements are provided, the first and second power feeding units are consequently disposed to face each other across the center point of the base member, on the diameter passing through the center of the base member. However, if the first and second power feeding units do not overlap each other, the first and second power feeding units can be laterally asymmetrical across the diameter. In this case, the other power feeding element is included in an arcuate region on the opposite side across the center point which is divided by two straight lines passing through the center of the base member from both ends of one power feeding element.

In the arm-wearable device according to the aspect of the invention, the arm-wearable device may further include a first wireless IC chip that processes a radio signal received by the first power feeding element, and a second wireless IC chip that processes a radio signal received by the second power feeding element. In planar view of the annular base member in a vertical direction, the first wireless IC chip and the second wireless IC chip may be respectively disposed inside a semicircular arc obtained by bisecting the annular base member.

In the arm-wearable device according to the aspect of the invention, it is preferable that the power feeding unit of the first power feeding element or the power feeding unit of the second power feeding element is disposed within a range from 3 o'clock to 9 o'clock of the time display unit, and receives a radio wave from a position information satellite.

In the arm-wearable device according to the aspect of the invention, either the first power feeding element or the second power feeding element whose received power is weaker than received power of the other power feeding element may be disposed within a range from 3 o'clock to 9 o'clock of the time display unit.

An antenna body according to another aspect of the invention includes an annular base member that is formed in a dielectric body, a first band-shaped power feeding element that is electrically conductive, and to which a predetermined potential is fed from a first power feeding unit, and a second band-shaped power feeding element that is electrically conductive, and to which a predetermined potential is fed from a second power feeding unit.

According to the above-described configuration, the first and second power feeding elements serving as at least two antennas are respectively disposed for each frequency or each wireless system of a radio wave to be received. The power feeding elements are caused to have a band shape (shape obtained by cutting a portion of an annular shape). In this manner, both of these can be disposed on the common annular base member. As a result, it is possible to avoid an increase in the number of base members. It is possible to avoid an increase in the thickness or a decreases in a display region in a case where multiple base members are provided. It is also possible to ensure visibility/design.

In the antenna body according to the aspect of the invention, in planar view of annular base member in a vertical direction, the first power feeding element and the second power feeding element may be disposed at a position where both of these do not overlap each other. According to this configuration, it is possible to avoid receiver sensitivity of the power feeding element located below from becoming poor due to the first and second power feeding elements overlapping each other. Therefore, it is possible to more reliably ensure the receiver sensitivity.

For example, the meaning of “both of these do not overlap each other” in the aspect of the invention includes a state where the first and second power feeding elements are respectively disposed inside the semicircular arc bisected by the diameter passing through the center of the base member, when the angle formed between both ends of the respective power feeding elements is 180° or smaller at the center point of the annular base member in both the first and second power feeding elements in a case where two power feeding elements are provided (refer to FIGS. 7A and 7B). In a case where two power feeding elements are provided, regardless of the angle formed between both ends of the power feeding elements, the two power feeding elements are disposed to face each other across the center of the base member on the diameter in which the center point of both ends of the power feeding elements passes through the center of the base member. In this manner, the two power feeding elements can be laterally symmetrical across the diameter (refer to FIGS. 7A and 7C). In this case, both ends are equally apart from each other to a maximum degree. Consequently, the respective center points of the power feeding elements are disposed to face each other across the center point of the base member. However, the invention is not limited thereto. If the first and second power feeding elements do not overlap each other, the two power feeding elements can be laterally asymmetrical across the diameter (refer to FIGS. 7B and 7D). Even in this case, when the angle formed between both ends of the respective power feeding elements is 180° or smaller, the first and second power feeding elements are respectively disposed inside the semicircular arc bisected by the diameter passing through the center of the base member (refer to FIG. 7B). Regardless of the angle formed between both ends of the power feeding elements, any one end portion of the other power feeding element is included in an arcuate region on the opposite side across the center point which is divided by two straight lines passing through the center of the base member from both ends of one power feeding element (refer to FIG. 7D).

In the antenna body according to the aspect of the invention, an annular or a band-shaped passive element which is electrically conductive may be disposed in the base member, apart from the first power feeding element and the second power feeding element.

The “passive element” in the aspect of the invention may maintain an insulated state apart from the first and second power feeding elements. For example, the “passive element” may be formed in another dielectric body separate from the base member, or may be formed together with the first and second power feeding elements on the base member. Similarly to the above-described power feeding element, for example, the “passive element” may be formed on the surface of the dielectric body by means of plating or silver paste printing, or may be incorporated into the dielectric body by means of insert-molding. According to this configuration, the power feeding element and the passive element are disposed apart from each other in the annular dielectric body.

In this case, if a current flows in the power feeding element, the current is also induced to the passive element. Accordingly, the power feeding element and the passive element are electromagnetically coupled to each other. Both of these are integrated, thereby functioning as an antenna element which converts an electromagnetic wave to a current. For example, in the power feeding element and the passive element which are disposed on the dielectric body, the length of the passive element is set to resonate with a receiving target radio wave. In this manner, the length of the power feeding element can be appropriately set. Therefore, it is possible to easily adjust impedance between the antenna body (the dielectric body and the power feeding element) and the passive element, and a circuit electrically connected to the antenna body. The passive element is electromagnetically coupled to the power feeding element. In this manner, it is possible to improve impedance characteristics by decreasing resonance frequencies of the antenna body. Accordingly, the resonance frequencies of the antenna body are caused to match a receiving target radio wave. In this manner, it is possible to improve receiving performance of the antenna body to receive the receiving target radio wave by reducing return loss in the resonance frequencies.

### BRIEF DESCRIPTION OF THE DRAWINGS

The invention will be described with reference to the accompanying drawings, wherein like numbers reference like elements.

FIG. 1 is a view illustrating a configuration of a time correction system using GPS.

FIG. 2 is a plan view of an electronic timepiece.

FIG. 3 is a sectional view illustrating a main part of the electronic timepiece.

FIG. 4 is an exploded perspective view illustrating a main part of the electronic timepiece.

FIG. 5 is a plan view illustrating a ground plate and a case body.

FIG. 6A is a view for describing a structure example of an antenna body.

FIG. 6B is a view for describing a structure example of the antenna body.

FIG. 6C is a view for describing a structure example of the antenna body.

FIG. 7A is a plan view illustrating an example of a position relationship between power feeding elements.

FIG. 7B is a plan view illustrating an example of the position relationship between the power feeding elements.

FIG. 7C is a plan view illustrating an example of the position relationship between the power feeding elements.

FIG. 7D is a plan view illustrating an example of the position relationship between the power feeding elements.

FIG. 8 is a block diagram illustrating a circuit configuration of the electronic timepiece.

### DESCRIPTION OF EXEMPLARY EMBODIMENTS

Hereinafter, a preferred embodiment according to the invention will be described with reference to the drawings. Dimension or scales of each unit in the drawings are appropriately different from those used in practice. The embodiment described below is a preferred specific example, and thus, various technically preferable limitations are given thereto. However, the scope of the invention is not limited to the embodiment unless otherwise described below so as to particularly limit the invention.

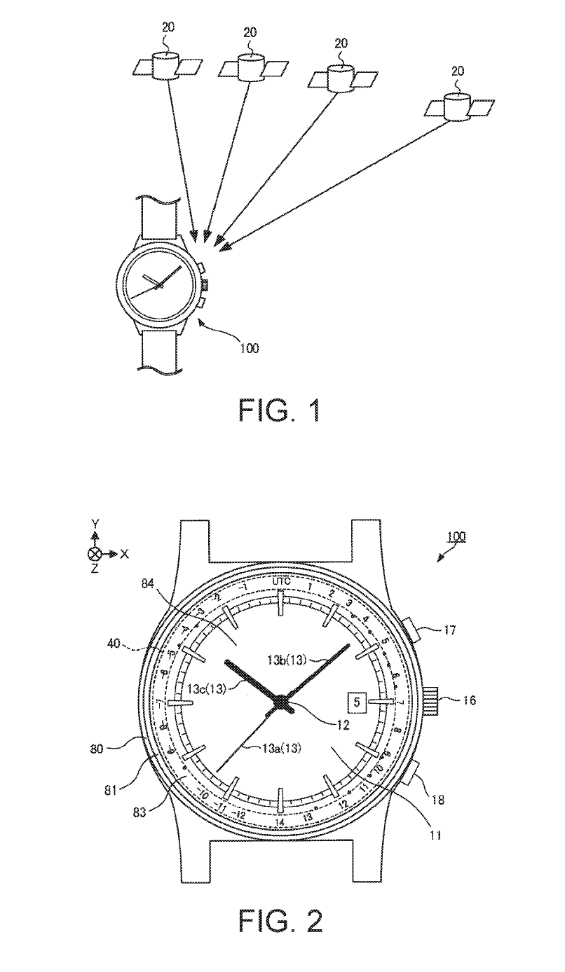

FIG. 1 is a view illustrating a configuration of a time correction system using GPS.

An electronic timepiece 100 is a wristwatch provided with a function to correct a time by receiving a radio wave (wireless signal) from GPS satellites 20, and displays the time on a surface (hereinafter, referred to as a front surface) opposite to a surface (hereinafter, referred to as a rear surface) in contact with an arm. The respective GPS satellites 20 turn around on a quasi-synchronous orbit, and transmit a coarse acquisition (C/A) code or a navigation message to the earth after superimposing the code or the message on a radio wave (L1 wave) of 1.57542 GHz. Hereinafter, in the following description, the radio wave of 1.57542 GHz is referred to as a “satellite signal”. For example, the satellite signal is a circularly polarized wave of a right-handed rotatory polarized wave.

The C/A code is a pseudo random noise code of inherent 1,023 bits per each GPS satellite 20. Each GPS satellite 20 has an atomic timepiece mounted thereon. The navigation message includes very accurate time information (hereinafter, referred to as GPS time information) measured by the atomic timepiece as a time that the GPS satellite 20 transmits the satellite signal. A time error of the atomic timepiece mounted on each GPS satellite 20 is measured by a control segment on the earth. The navigation message includes a time correction parameter for correcting the time error. In addition, for example, the navigation message includes accurate orbit information (ephemeris) of the GPS satellite 20, rough orbit information (almanac) of all of the GPS satellites 20, UTC offset indicating deviation between a coordinated universal time (UTC) time system and a GPS time system, and an ionosphere correction parameter.

After the navigation message is subjected to spread spectrum by the C/A code, each GPS satellite 20 multiplies a carrier wave of 1.57542 GHz by a spread spectrum signal, and generates the satellite signal through binary phase shift keying (BPSK) modulation. The electronic timepiece 100 takes out the navigation message from the received satellite signal in the inverse flow compared to the signal generation in the GPS satellite 20 (demodulation of the BPSK modulation signal→inverse spread spectrum). The C/A code used at the time of the spread spectrum varies depending on each GPS satellite 20. Accordingly, the electronic timepiece 100 can identify that the satellite signal is transmitted from any GPS satellite 20.

For example, the electronic timepiece 100 can correct a time measured by the electronic timepiece 100 (hereinafter, referred to as an internal time) to an accurate time by using the GPS time information or the time correction parameter included in the satellite signal received from one GPS satellite 20. For example, the electronic timepiece 100 can acquire position information (for example, latitude and longitude) indicating a current position of the electronic timepiece 100 by receiving the satellite signals from at least three (usually four) or more GPS satellites 20 and the GPS time information or the orbit information (ephemeris) of each GPS satellite 20, which is included in the satellite signal. For example, the acquired position information is used for correcting a time difference.

The electronic timepiece 100 calculates a distance from the GPS satellite 20, based on a difference between an arrival time of the satellite signal and a transmission time included in the satellite signal. Based on the distance from the respective three or more GPS satellites 20, the electronic timepiece 100 identifies the current position of the electronic timepiece 100. However, the electronic timepiece 100 uses a quartz oscillator, and thus, cannot very accurately measure the time, unlike the atomic timepiece. For example, even if a time error is one-millionth seconds, a distance error occurs up to 300 meters. Therefore, the electronic timepiece 100 receives the satellite signals from normally four or more GPS satellites 20, and acquires the position information while correcting the internal time.

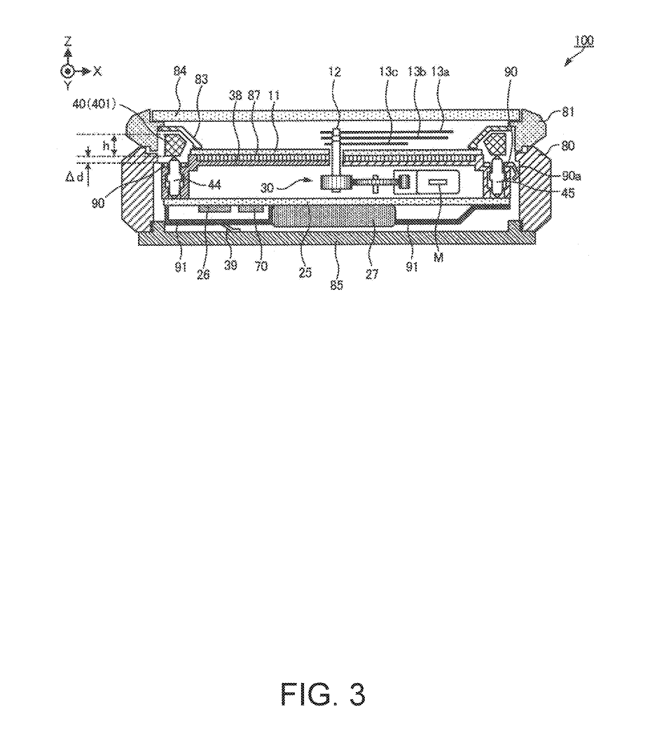

FIG. 2 is a plan view of the electronic timepiece 100.

The electronic timepiece 100 includes a cylindrical case body 80 formed of a conductive material such as metal. A cylindrical glass edge 81 formed of a non-conductive material such as ceramic and plastic is fitted to an upper side (front surface side) of the case body 80. An opening of the glass edge 81 is covered with a transparent cover glass 84.

An annular dial ring 83 formed of a non-conductive material such as ceramic and plastic is disposed inside the glass edge 81, and a disc-shaped dial 11 is disposed inside the dial ring 83. Bar-type indices are disposed at every 30 degrees in the dial ring 83. The respective indices partially protrude on the dial 11. Scales are marked at every 6 degrees between the indices adjacent to each other in the dial ring 83. The indices or the scales may be disposed in the dial 11, or numbers “1” to “12” may be disposed instead of the indices. In this way, the dial ring 83 or the dial 11 is not limited to an illustrated form. Indicating hands 13 (a second hand 13a, a minute hand 13b, and an hour hand 13c) which turn around on an indicating hand axle 12 as the center so as to indicate a current time are disposed on the dial 11. A user can view the dial ring 83, the dial 11, and the indicating hands 13 via the cover glass 84. An annular antenna body 40 is disposed on a lower side (rear surface side) of the dial ring 83.

A display form of the electronic timepiece 100 includes a form in which the indicating hand turns around the indicating hand axle as the center on the dial so as to indicate a time. In addition, for example, the display form includes a form in which a liquid-crystal display panel having a display region having a size corresponding to the dial is provided so as to display a time by displaying the dial or an image of the indicating hand on the display region, or a form in which a time is displayed on the liquid-crystal display panel in a digital manner. The “annular shape” may be a wheel whose entire body is connected without being cut. A shape of the wheel (ring) may be circular or elliptical. Alternatively, the shape may be polygonal such as square.

The electronic timepiece 100 includes a crown 16, and operation buttons 17 and 18. A user can set an operation mode of the electronic timepiece 100 to a time information acquisition mode or a position information acquisition mode by operating the crown 16 or the operation buttons 17 and 18. The time information acquisition mode is an operation mode in which the internal time is corrected to an accurate time by receiving the satellite signal from at least one GPS satellite 20 and acquiring the GPS time information or the time correction parameter. The position information acquisition mode is an operation mode in which the internal time is corrected to an accurate time while a time difference is reflected by receiving the satellite signals from at least three or more GPS satellites 20 and acquiring the position information of the electronic timepiece 100. The electronic timepiece 100 can periodically and automatically switch between the time information acquisition mode and the position information acquisition mode.

Next, an internal structure of the electronic timepiece 100 will be described.

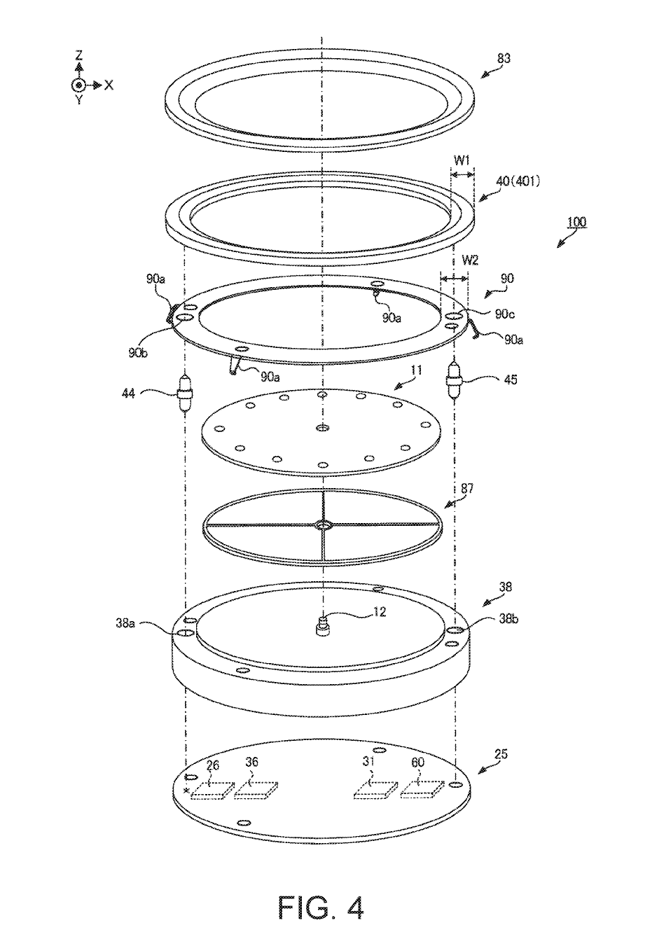

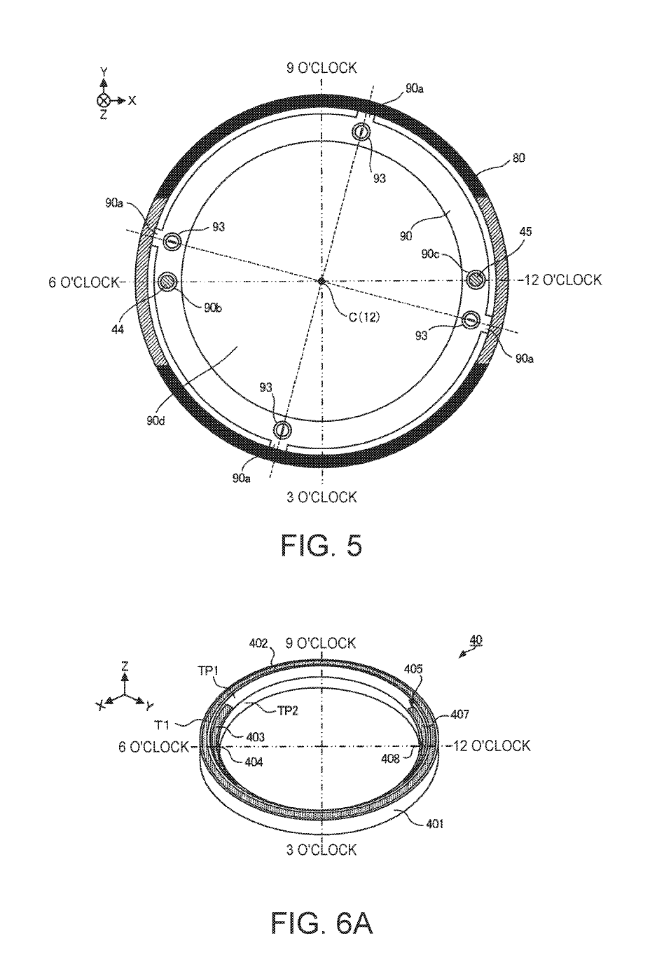

FIG. 3 is a sectional view illustrating a main part of the electronic timepiece 100. FIG. 4 is an exploded perspective view illustrating a main part of the electronic timepiece 100. As illustrated in FIG. 3, the cylindrical glass edge 81 is fitted to the upper side (front surface side) of the cylindrical case body 80. An opening on the upper side of the glass edge 81 is covered with the disc-shaped cover glass 84. An opening on the lower side (rear surface side) of the case body 80 is covered with a rear cover 85 formed of a conductive material such as stainless steel and titanium. For example, the case body 80 and the rear cover 85 are fixed to a screw groove. In this way, for example, the exterior case of the electronic timepiece 100 is configured to include the case body 80, the glass edge 81, the cover glass 84, and the rear cover 85.

The annular dial ring 83 is disposed along the inner periphery of the glass edge 81 on the lower side of the cover glass 84. In the dial ring 83, the outer peripheral side is a flat portion which comes into contact with the inner peripheral surface of the glass edge 81, and the inner peripheral side is an inclined portion which is inclined inward. A donut-shaped accommodating space is disposed on the lower side of the dial ring 83. The annular antenna body 40 is accommodated in the accommodating space. The antenna body 40 is disposed around the dial 11. Specifically, the antenna body 40 is disposed inward from the inner periphery of the case body 80 or the glass edge 81, and the upper portion of the antenna body 40 is covered with the dial ring 83.

An annular ground plate 90 formed of a conductive material such as metal is disposed on the lower side of the antenna body 40. As illustrated in FIG. 4, the ground plate 90 has four holes in addition to an insertion hole 90b for a power feeding pin 44 and an insertion hole 90c for a power feeding pin 45. A conduction pin 93 (not illustrated) is attached to each of the four holes. The four holes for attaching the conduction pin 93 thereto are also disposed in a main plate 38 or an peripheral edge portion of a circuit board 25 in addition to the ground plate 90 (refer to FIG. 4).

A ground potential of a circuit block including a GPS receiver 26 is supplied to each conduction pin 93 via the circuit board 25. The ground potential is supplied to the ground plate 90 from each of a total of four conduction pins 93. As illustrated in FIG. 4, four conduction springs 90a are formed in the ground plate 90. Each conduction spring 90a is partially brought into contact with the inner peripheral surface of the case body 80 by using a biasing force. Each conduction spring is electrically connected to the case body 80. Therefore, the ground potential is also supplied to the case body 80 via the ground plate 90 (each conduction spring 90a).

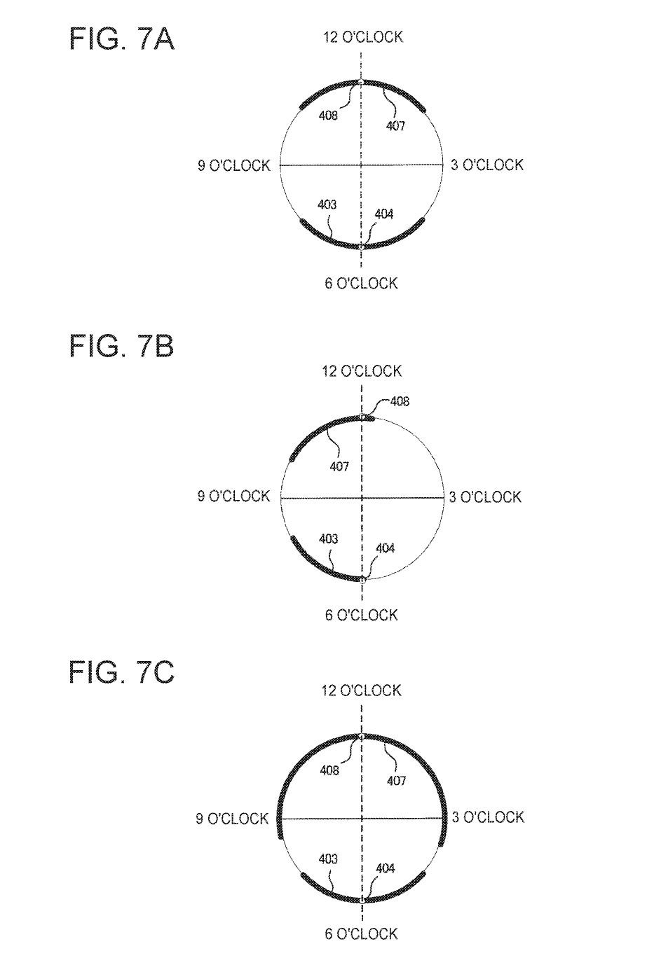

Although details will be described later, the antenna body 40 is configured to include an annular base member 401 formed in a dielectric body, a passive element 402 disposed on the base member 401, and power feeding elements 403 and 407 (refer to FIG. 6A). As illustrated in FIG. 4, the base member 401 of the antenna body 40 and the ground plate 90 have the same annular center axis, and the center axis coincides with the indicating hand axle 12. As illustrated in FIG. 3, when a width of the antenna body 40 in a Z-axis direction of the base member 401 is set to h, a spaced distance Δd in the Z-axis direction between the base member 401 and the ground plate 90 is equal to or smaller than h. In this way, the base member 401 of the antenna body 40 and the ground plate 90 are disposed side by side in the Z-axis direction so as to have the same annular center axis and so that the spaced distance Δd in the Z-axis direction is equal to or smaller than h. The reason that the spaced distance Δd between the antenna body 40 (base member 401) and the ground plate 90 is set to be equal to or smaller than h is to receive a radio wave (satellite signal) by generating resonance between the ground plate 90 and the power feeding element 403 disposed on the base member 401. If the spaced distance Δd is excessively far, the resonance is not generated between both of these. Consequently, the radio wave cannot be received.

In order to satisfactorily generate the resonance between the ground plate 90 and the power feeding element 403 disposed on the base member 401, it is desirable to increase an outer peripheral size of the ground plate 90 further than an outer peripheral size of the base member 401 of the antenna body 40. In addition, it is desirable to increase a width W2 on an XY plane of the ground plate 90 further than a width W1 on an XY plane of the base member 401 of the antenna body 40 (refer to FIG. 4). However, the outer peripheral size of the ground plate 90 may be set to be equal to or smaller than the outer peripheral size of the base member 401, or the width W2 of the ground plate 90 may be set to be equal to or smaller than the width W1 of the base member 401. However, in a case where the outer peripheral size of the ground plate 90 is set to be equal to or smaller than the outer peripheral size of the base member 401, at least the width W2 of the ground plate 90 needs to be one-third of or greater than the width W1 of the base member 401.

The dial 11 and a solar panel 87 are disposed inside the antenna body 40. The dial 11 is formed of a light-transmitting and non-conductive material such as plastic. The solar panel 87 is a circular flat plate in which multiple solar cells (photovoltaic elements) for converting light energy into electric energy (electric power) are connected in series. The dial 11 and the solar panel 87 are disposed to overlap each other. A hole into which the indicating hand axle 12 penetrates is disposed at the center of both of these.

The main plate 38 formed of a non-conductive material such as plastic and ceramic is disposed on the lower side of the solar panel 87. The indicating hand axle 12 extends in a forward and rearward direction after penetrating into the dial 11, the solar panel 87, and the main plate 38. The indicating hand axle 12 serves as the center of the electronic timepiece 100, when the electronic timepiece 100 is viewed in a direction perpendicular to the dial 11 (that is, in planar view of the electronic timepiece 100). As illustrated in FIG. 3, the indicating hand 13(13a to 13c) are disposed between the cover glass 84 and the dial 11, inward from the inner periphery of the antenna body 40.

As illustrated in FIG. 3, a drive mechanism 30 for driving the indicating hand 13 by rotating the indicating hand axle 12 is disposed on the lower side of the main plate 38. The drive mechanism 30 has a stepping motor M and a train wheel of gears, and drives the indicating hand 13 in such a way that the stepping motor M rotates the indicating hand axle 12 via the wheel train. For example, the hour hand 13c revolves once in 12 hours. The minute hand 13b revolves once in 60 minutes. The second hand 13a revolves once in 60 seconds. For example, a date and time display unit 32 is configured to include the dial 11, the indicating hand axle 12, the indicating hand 13 (13a to 13c), and the drive mechanism 30.

The circuit board 25 is disposed on the lower side of the main plate 38 and the drive mechanism 30. A circuit block including a GPS receiver 26 and a short-range wireless communication receiver 60 is mounted on the lower surface (surface on the rear surface side) of the circuit board 25. For example, the GPS receiver 26 and the short-range wireless communication receiver 60 are configured to include an IC module of one chip, and include an analog circuit or a digital circuit. A display control unit 36 controls an operation of the GPS receiver 26 and the drive mechanism 30. An information processing unit 31 controls an operation of the short-range wireless communication receiver 60 and the display unit 70. A secondary battery 27 is disposed on the lower surface of the circuit board 25 (refer to FIG. 3). For example, the secondary battery 27 is a lithium ion battery, and is charged with power generated by the solar panel 87.

The circuit board 25 has a wiring pattern formed in order to supply a predetermined potential for feeding power to the antenna body 40. The power feeding pin 44 is a pin-shaped connector formed of a conductive material such as metal, and has a coil spring incorporated therein. As illustrated in FIG. 4, the power feeding pin 44 electrically connects a top surface of the circuit board 25 and a bottom surface of the antenna body 40 to each other via insertion holes 38a and 90b disposed in the main plate 38 and the ground plate 90. As illustrated in FIG. 4, the power feeding pin 45 electrically connects the top surface of the circuit board 25 and the bottom surface of the antenna body 40 to each other via insertion holes 38b and 90c disposed in the main plate 38 and the ground plate 90.

Each upper end portion of the power feeding pins 44 and 45 is brought into contact with the bottom surface (more specifically, joints 404 and 408 to be described later) of the antenna body 40 by using a biasing force of a coil spring. Each lower end portion of the power feeding pins 44 and 45 is brought into contact with the top surface (more specifically, a portion having the wiring pattern for feeding the predetermined potential) of the circuit board 25 by using a biasing force of a coil spring. The predetermined potential is fed to the antenna body 40 via the power feeding pins 44 and 45.

As illustrated in FIG. 3, the GPS receiver 26, the information processing unit 31, the short-range wireless communication receiver 60, and the display control unit 36 are covered with a shield plate 91 formed of a conductive material such as metal. The ground potential is fed to the shield plate 91. The ground potential is also fed to the rear cover 85 and the case body 80 via the shield plate 91 and a metal-made circuit holder 39. As described above, the ground potential is also fed to the ground plate 90 and the case body 80 via the circuit board 25 and each conduction pin 93. Therefore, the ground potential is fed to the ground plate 90 through a route by way of the circuit board 25 and each conduction pin 93. In addition, the ground potential is also fed to the ground plate 90 through a route by way of the shield plate 91, the circuit holder 39, the rear cover 85, the case body 80, and each conduction spring 90a. The case body 80 and the rear cover 85 to which the ground potential is fed in the exterior case function as a ground plate, which reflects the satellite signal incident from the cover glass 84 side toward the antenna body 40.

Respective members (for example, the shield plate 91, the circuit holder 39, the rear cover 85, the conduction pin 93, the ground plate 90, and the conduction spring 90a) configuring a feeding route of the ground potential are subjected to gold plating or plating for rust prevention on a contact surface between the members. The respective conduction pins 93 are fixed by means of screw fastening. This minimizes contact resistance as much as possible for a long period of time between the respective members configuring the feeding route of the ground potential.

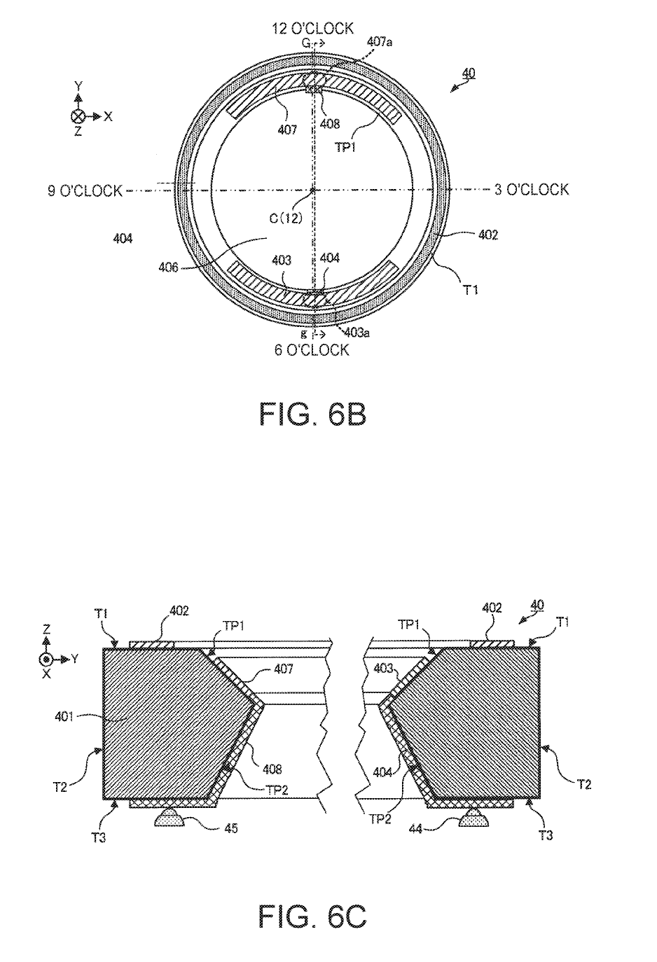

FIG. 5 is a plan view illustrating the ground plate 90 and the case body 80.

The ground plate 90 has the insertion hole 90b into which the power feeding pin 44 is inserted, in a direction of 6 o'clock when viewed from an annular center C (indicating hand axle 12) of the ground plate 90. In addition, the ground plate 90 has the insertion hole 90c into which the power feeding pin 45 is inserted, in a direction of 12 o'clock when viewed from the annular center C (indicating hand axle 12) of the ground plate 90. Four conduction pins 93 are attached to the ground plate 90 from the center C at an equal angle (90 degrees). The ground potential is fed to the ground plate 90 from each of the conduction pins 93. Four conduction springs 90a formed integrally with the ground plate 90 are disposed in an outer peripheral edge of the ground plate 90 from the center C at an equal angle (90 degrees). The respective conduction springs 90a are partially brought into contact with an inner peripheral surface of the case body 80 by using a biasing force. In this manner, the ground potential is also fed from the case body 80 to the ground plate 90 via the respective conduction springs 90a. The ground plate 90 has a circular opening portion 90d at the center of the ground plate 90.

In this way, as a feeding portion to which the ground potential is fed, the ground plate 90 has a total of 8 locations for the conduction pins 93 and the conduction springs 90a. Therefore, the ground potential can be stabilized in the ground plate 90. In a case where the electronic timepiece 100 is worn on the arm, a human body can be utilized as the ground via the rear cover 85 or the case body 80. Accordingly, it is possible to further stabilize the ground potential.

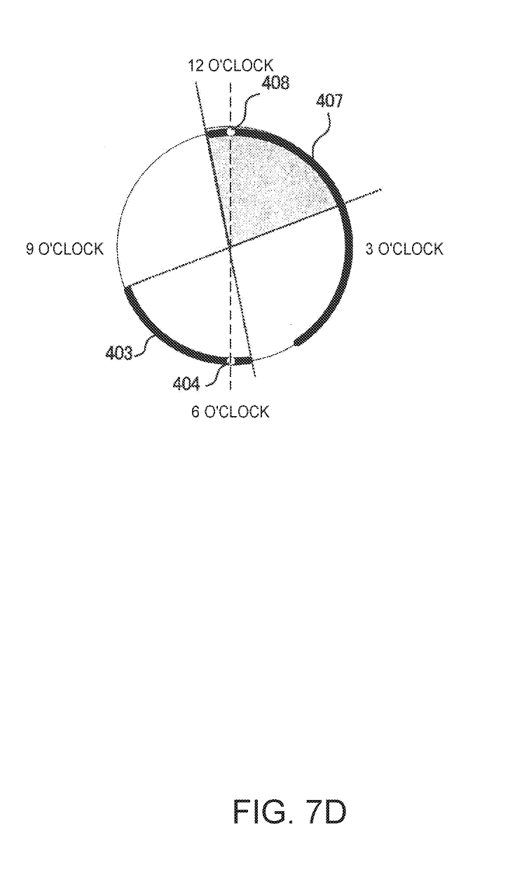

FIGS. 6A to FIG. 6C are views for describing a structure of the antenna body 40. FIGS. 7A to 7D are plan views illustrating a position relationship between the power feeding elements.

FIG. 6A is a perspective view of the antenna body 40. FIG. 6B is a plan view of the antenna body 40. FIG. 6C is a sectional view in which the antenna body 40 is cut along line G-g illustrated in FIG. 6B.

The antenna body 40 includes the annular base member 401 formed in a dielectric body such as plastic and ceramic, the passive element 402 formed on the front surface of the base member 401, the conductive power feeding elements 403 and 407 to which a predetermined potential is fed, and the joints 404 and 408. The base member 401 has a cylindrical opening portion 406 at the center of the base member 401. The passive element 402, the power feeding elements 403 and 407, and the joints 404 and 408 are all formed of a conductive material such as metal, and can be formed by means of plating or silver paste printing, for example. The passive element 402, the power feeding elements 403 and 407, and the joints 404 and 408 may be incorporated into the dielectric body by means of insert-molding. As a material of the base member 401, a dielectric material which can be used for the high frequency such as titanium oxide is mixed with a resin, thereby adjusting a relative dielectric constant to become approximately 5 to 20.

As illustrated in FIG. 6C, the base member 401 has a cross-sectional shape of a pentagon surrounded with a top surface T1, an outer peripheral surface T2, a bottom surface T3, an inclined surface TP1, and an inclined surface TP2. The passive element 402 is formed on the top surface T1. The power feeding element 403 and 407 are formed on the inclined surface TP1. The joint 404 and 408 are formed along the inclined surface TP1, the inclined surface TP2, and the bottom surface T3. An end portion on the inclined surface TP1 side in the joint 404 is connected to the power feeding element 403. An upper end portion of the power feeding pin 44 is in contact with an end portion on the bottom surface T3 side in the joint 404. Therefore, a predetermined potential is fed to the power feeding element 403 via the power feeding pin 44 and the joint 404. An end portion on the inclined surface TP1 side in the joint 408 is connected to the power feeding element 407. An upper end portion of the power feeding pin 45 is in contact with an end portion on the bottom surface T3 side in the joint 408. Therefore, a predetermined potential is fed to the power feeding element 407 via the power feeding pin 45 and the joint 408. On the other hand, no potential is fed to the passive element 402 from the outside.

As illustrated in FIGS. 6A and 6B, the passive element 402 is formed in an annular shape, that is, in an endless O-shape. On the other hand, the power feeding element 403 is formed to be a semicircular arch having a band shape (circular ring is partially cut). The power feeding element 403 receives a radio wave from a position information satellite, and has an antenna length which resonates with the radio wave (satellite signal) from the GPS satellite 20. The joint 404 is connected to a central portion of the power feeding element 403 having the semicircular arc shape. As illustrated in FIG. 6B, a portion connected to the joint 404 in the power feeding element 403 serves as the power feeding unit 403a to which a predetermined potential is fed. Without being limited to a form in which the power feeding unit 403a is disposed in the central portion of the power feeding element 403, the power feeding unit 403a may be disposed in a portion other than the central portion in the power feeding element 403.

The power feeding element 407 is formed to be a semicircular arch having a band shape (circular ring is partially cut). The power feeding element 407 has an antenna length which resonates with a radio wave of 2.4 GHz for the short-range wireless communication. The joint 408 is connected to a central portion of the power feeding element 407 having the semicircular arc shape. As illustrated in FIG. 6B, a portion connected to the joint 408 in the power feeding element 407 serves as the power feeding unit 407a to which a predetermined potential is fed. Without being limited to a form in which the power feeding unit 407a is disposed in the central portion of the power feeding element 407, the power feeding unit 407a may be disposed in a portion other than the central portion in the power feeding element 407.

According to the present embodiment, in the two power feeding elements, one power feeding element whose received power is weaker than the received power of the other power feeding element is disposed within a range of 6 o'clock of the dial 11. Specifically, the power feeding unit 403a is disposed in the direction of 6 o'clock in the electronic timepiece 100. That is, in planar view of the electronic timepiece 100, the power feeding unit 403a, the joint 404, and the power feeding pin 44 are disposed in the direction of 6 o'clock when viewed from the center (indicating hand axle 12) of the electronic timepiece 100. However, without being limited to the direction of 6 o'clock when viewed from the center of the electronic timepiece 100, the power feeding unit 403a, the joint 404, and the power feeding pin 44 may be installed in the direction of 8 o'clock, in the direction of 10 o'clock, in the direction of 5 o'clock, or in the direction of 1 o'clock, for example.

On the other hand, the power feeding unit 407a is disposed in the direction of 12 o'clock in the electronic timepiece 100. That is, in planar view of the electronic timepiece 100, the power feeding unit 407a, the joint 408, and the power feeding pin 45 are disposed in the direction of 12 o'clock when viewed from the center (indicating hand axle 12) of the electronic timepiece 100. However, without being limited to the direction of 12 o'clock when viewed from the center of the electronic timepiece 100, the power feeding unit 407a, the joint 408, and the power feeding pin 45 may be installed in the direction of 8 o'clock, in the direction of 10 o'clock, in the direction of 5 o'clock, or in the direction of 1 o'clock, for example.

In the embodiment, as illustrated in FIGS. 7A to 7D, in planar view of the power feeding elements 403 and 407 in the direction of the annular center axis (indicating hand axle 12) of the base member 401, the power feeding elements 403 and 407 are respectively disposed at a position where both of these do not overlap each other. Here, the position where both of these do not overlap each other includes a state where the power feeding elements 403 and 407 are respectively disposed inside the semicircular arc bisected by the diameter passing through the center of the base member 401, when an angle formed between both ends of the respective power feeding elements is 180° or smaller at the center point of the annular base member 401 in both the power feeding elements 403 and 407 in a case where two power feeding elements are provided (refer to FIGS. 7A and 7B).

In a case where two power feeding elements are provided, regardless of the angle formed between both ends of the power feeding elements, the two power feeding elements are disposed to face each other across the center of the base member 401 on the diameter in which the center point of both ends of the power feeding elements passes through the center of the base member 401. In this manner, the two power feeding elements can be laterally symmetrical across the diameter (refer to FIGS. 7A and 7C). In this case, both ends are equally apart from each other to a maximum degree. Consequently, the respective center points of the power feeding elements are disposed to face each other across the center point of the base member 401.

However, the invention is not limited thereto. If the power feeding elements 403 and 407 do not overlap each other, the two power feeding elements can be laterally asymmetrical across the diameter (refer to FIGS. 7B and 7D). Even in this case, when the angle formed between both ends of the respective power feeding elements is 180° or smaller, the power feeding elements 403 and 407 are respectively disposed inside the semicircular arc bisected by the diameter passing through the center of the base member 401 (refer to FIG. 7B). Regardless of the angle formed between both ends of the power feeding elements, any one end portion of the other power feeding element is included in an arcuate region on the opposite side across the center point which is divided by two straight lines passing through the center of the base member 401 from both ends of one power feeding element (refer to FIG. 7D).

In planar view of the base member 401 in the direction of the annular center axis, the power feeding unit 403a is disposed within a region of the power feeding element 403 as illustrated in FIGS. 7A to 7D. In planar view of the base member 401 in the direction of the annular center axis, the power feeding unit 407a is disposed within a region of the power feeding element 407 as illustrated in FIGS. 7A to 7D. Then, the power feeding elements 403 and 407 are respectively disposed at a position where both of these do not overlap each other.

Here, similarly to the above-described power feeding elements 403 and 407, for example, the “position where the power feeding units do not overlap each other” includes a state where the power feeding units are respectively disposed inside the semicircular arc bisected by the diameter passing through the center of the base member 401. When the first and second power feeding units are apart from each other to a maximum degree in a case where two power feeding elements 403 and 407 are provided, the power feeding units are consequently disposed to face each other across the center point of the base member 401, on the diameter passing through the center of the base member 401. However, if the first and second power feeding units do not overlap each other, the power feeding units can be laterally symmetrical across the diameter. In this case, the other power feeding element is included in an arcuate region on the opposite side across the center point which is divided by two straight lines passing through the center of the base member 401 from both ends of one power feeding element in the power feeding elements 403 and 407.

As illustrated in FIGS. 6A and 6B, the conducive passive element 402 having an annular shape or a band shape (shape obtained by cutting a portion of an annular shape) is disposed apart from the power feeding elements 403 and 407. If a current flows in any one power feeding element, the current is also induced to the passive element 402.

That is, if the current flows in the passive element 402 and any one power feeding element in the power feeding elements 403 and 407, a spaced distance of the passive element 402 is set to a distance which enables electromagnetic coupling between both of these. Therefore, the power feeding elements 403 and 407, and the passive element 402 are integrated with each other, thereby functioning as an antenna element which converts an electromagnetic wave to a current. For example, in the power feeding elements 403 and 407, and the passive element 402 which are disposed on the dielectric body, the length of the passive element 402 is set to resonate with a receiving target radio wave. In this manner, the length of the power feeding elements 403 and 407 can be appropriately set. Therefore, it is possible to easily adjust impedance between the antenna body 40 (the dielectric body, the power feeding elements 403 and 407) and the passive element 402, and a circuit electrically connected to the antenna body 40. Since the passive element 402 has an O-shape, the antenna body 40 functions as a loop antenna having an O-shape as a whole.

In the embodiment, the electronic timepiece 100 generates the resonance between the power feeding element 403 to which a predetermined potential is fed and the ground plate 90 to which the ground potential is fed, and receives a radio wave (satellite signal) from the GPS satellite 20 by using the resonance. For example, since the satellite signal from the GPS satellite 20 shows 1.575 GHz, one wavelength is approximately 19 cm. In order to receive a circularly polarized wave, the antenna length needs to be approximately 1.0 to 1.2 times the wavelength. Accordingly, in order to receive the satellite signal, the length of the loop antenna needs to be approximately 19 to 24 cm. If the loop antenna having the antenna length in this way is accommodated inside a wristwatch, a size of the wristwatch has to increase consequently.

For example, when a relative dielectric constant is set to εr, if the base member 401 whose relative dielectric constant is εr is used, a wavelength shortening coefficient realized by the base member 401 is 1/√εr. That is, since the dielectric body whose relative dielectric constant is εr is used, it is possible to shorten the wavelength of the receiving target radio wave of the antenna body 40 as much as 1/√εr times. As described above, the relative dielectric constant εr of the base member 401 is approximately 5 to 20. Accordingly, compared to a case without including the base member 401, the antenna length of the antenna body 40 can be shortened as much as approximately 0.224 (εr=20) to 0.447 (εr=5) times.

The passive element 402 is electromagnetically coupled to the power feeding elements 403 and 407. In this manner, it is possible to improve impedance characteristics by decreasing resonance frequencies of the antenna body 40. Accordingly, the resonance frequencies of the antenna body 40 are caused to match the receiving target radio wave. In this manner, it is possible to improve receiving performance of the antenna body 40 to receive the receiving target radio wave by reducing return loss in the resonance frequencies.

Not only a contact surface between the power feeding pins 44 and 45, and the joints 404 and 408 but also a contact surface between the power feeding pins 44 and 45, and the circuit board 25 are subjected to gold plating or plating for rust prevention. In this manner, contact resistance is minimized as much as possible for a long period of time, thereby preventing the receiving performance of the antenna body 40 from becoming poor. In the embodiment, the passive element 402 is formed on the base member 401. However, the passive element 402 may maintain an insulated state apart from the power feeding elements 403 and 407 which are formed on the base member 401 together with the passive element 402. For example, the passive element 402 may be formed on another dielectric body separate from the base member 401. Similarly to the above-described power feeding element, for example, the passive element 402 may be formed on the front surface of the dielectric body by means of plating or silver paste printing, or may be incorporated into the dielectric body by means of insert-molding.

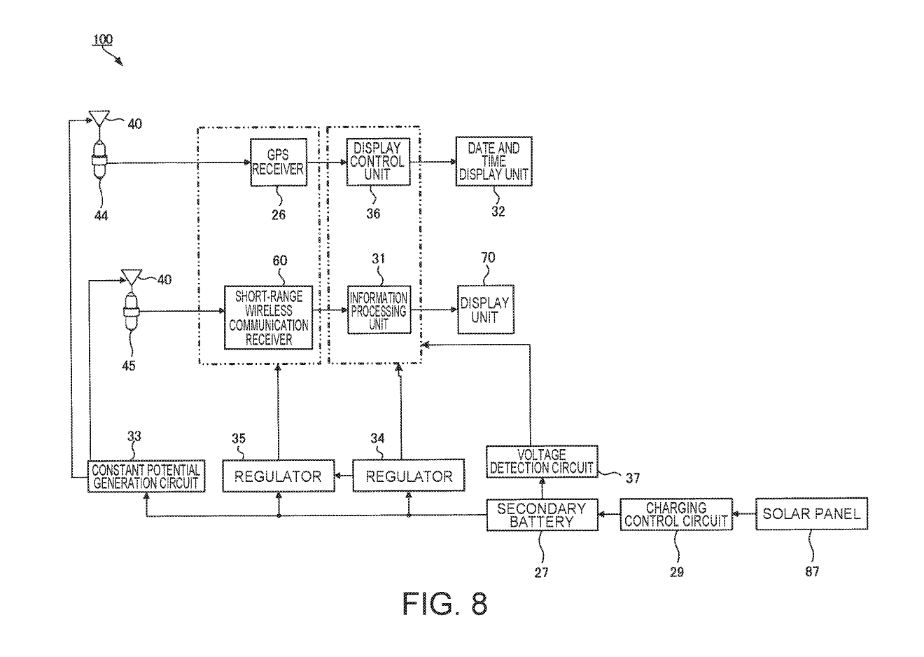

FIG. 8 is a block diagram illustrating a configuration of the electronic timepiece 100.

The electronic timepiece 100 is configured to include the solar panel 87, a constant potential generation circuit 33, the secondary battery 27, a voltage detection circuit 37, regulators 34 and 35, a GPS receiver 26, a display control unit 36, the date and time display unit 32, the short-range wireless communication receiver 60, the information processing unit 31, and the display unit 70.

The solar panel 87 charges the secondary battery 27 via a charging control circuit 29. The secondary battery 27 supplies drive power to the display control unit 36 and the information processing unit 31 via the regulator 34, and supplies the drive power to the GPS receiver 26 and the short-range wireless communication receiver 60 via the regulator 35. The voltage detection circuit 37 detects a voltage of the secondary battery 27, and outputs the voltage to the display control unit 36 and the information processing unit 31.

The constant potential generation circuit 33 generates a predetermined potential having a preset potential difference from that of the ground potential. The predetermined potential generated by the constant potential generation circuit 33 is fed to the antenna body 40 (power feeding elements 403 and 407) via the circuit board 25 and the power feeding pins 44 and 45.

The antenna body 40 receives the satellite signal from the GPS satellite 20. However, the antenna body 40 receives an unnecessary radio wave a little bit in addition to the satellite signal. Accordingly, a surface acoustic wave (SAW) filter may be disposed in a rear stag of the antenna body 40. The SAW filter functions as a band pass filter for passing a signal of 1.5 GHz band, and extracts the satellite signal from the signal received by the antenna body 40.

The GPS receiver 26 processes the radio signal received by the power feeding element 403, and performs processes relating to receiving the satellite signal, tracing the GPS satellite 20, generating position information, and generating time correction information. The display control unit 36 outputs a control signal to the GPS receiver 26, and controls an operation of the GPS receiver 26. The display control unit 36 performs processes relating to measuring or correcting the internal time and operating the indicating hand 13.

The short-range wireless communication receiver 60 processes the radio signal received by the power feeding element 407, and uses a protocol for data communication so as to perform short-range wireless communication. Specifically, the short-range wireless communication receiver 60 is a device for reading data from or writing data on a memory in a short-range, and enables data exchange with a peripheral device such as a personal computer and a smartphone. In planar view of the base member 401 in the vertical direction (in the direction of the annular center axis), in the short-range wireless communication receiver 60 and the GPS receiver 26, the wireless IC chips are respectively disposed inside the semicircular arc obtained by bisecting the annular base member 401.

If the time correction information is output from the GPS receiver 26 in a case of the time information acquisition mode or the position information acquisition mode, the display control unit 36 corrects the internal time in accordance with the time correction information. In a case of correcting the internal time, the display control unit 36 drives the indicating hand 13 so that the indicating hand 13 (13a to 13c) indicates the corrected internal time. In this manner, the internal time of the electronic timepiece 100 is corrected to an accurate time. Particularly in a case of position information acquisition mode, the internal time can be corrected to the accurate time while a time difference is reflected in accordance with the current position of the electronic timepiece 100. Based on a detection result of the voltage detection circuit 37, the display control unit 36 controls an operation of the regulator 34 and 35 or the constant potential generation circuit 33.

The date and time display unit 32 displays date and time information processed by the display control unit 36 on a screen. In the embodiment, the date and time display unit 32 includes the dial 11 and the indicating hand 13.

The information processing unit 31 controls data exchange using wireless communication such as the short-range wireless communication. The display unit 70 displays information relating to exchange of the data processed by the information processing unit 31, on the screen.

According to the above-described embodiment, the power feeding elements 403 and 407 serving as at least two antennas are respectively disposed for each frequency or each wireless system of the radio wave to be received. The power feeding elements are caused to have a band shape. In this manner, both of these can be disposed on the common annular base member 401. As a result, it is possible to avoid an increase in the number of base members 401, and it is possible to avoid an increase in the thickness or a decreases in the display region that occur in a case where multiple base members 401 are provided, and therefore visibility and design are ensured. The wireless IC chip can be disposed below apart from the antenna body 40 in the direction of viewing the dial 11 via the power feeding pin from the power feeding unit. Therefore, it is possible to avoid poor design while receiver sensitivity is ensured.

According to the embodiment described herein, in planar view of the annular base member 401 in the vertical direction (in the direction of the annular center axis), the power feeding elements 403 and 407 are respectively disposed at a position where both of these do not overlap each other. According to this configuration, it is possible to avoid poor receiver sensitivity of the power feeding element located below that occurs in a case where the power feeding elements 403 and 407 overlap each other. Therefore, it is possible to more reliably ensure the receiver sensitivity.

According to the embodiment described herein, the passive element 402 is disposed apart from the power feeding elements 403 and 407. Accordingly, if a current flows in the power feeding elements 403 and 407, the current is also induced to the passive element 402. Accordingly, the power feeding elements 403 and 407 and the passive element 402 are electromagnetically coupled to each other. Both of these are integrated, thereby functioning as an antenna element which converts an electromagnetic wave to a current. For example, in the power feeding elements 403 and 407 and the passive element 402 which are disposed on the dielectric body, the length of the passive element 402 is set to resonate with a receiving target radio wave. In this manner, the length of the power feeding elements 403 and 407 can be appropriately set. Therefore, it is possible to easily adjust impedance between the antenna body 40 (the dielectric body, the power feeding elements 403 and 407) and the passive element 402, and a circuit electrically connected to the antenna body 40.

The passive element 402 is electromagnetically coupled to the power feeding elements 403 and 407. In this manner, it is possible to improve impedance characteristics by decreasing resonance frequencies of the antenna body 40. Accordingly, the resonance frequencies of the antenna body 40 are caused to match the receiving target radio wave. In this manner, it is possible to improve receiving performance of the antenna body 40 to receive the receiving target radio wave by reducing return loss in the resonance frequencies.

According to the embodiment described herein, in planar view of the annular base member 401 in the vertical direction, the power feeding unit 403a is disposed in the region of the power feeding element 403, and the power feeding unit 407a is disposed in the region of the power feeding element 407. The power feeding elements 403 and 407 are respectively disposed at a position where both of these do not overlap each other.

According to the embodiment described herein, the electronic timepiece 100 includes the GPS receiver 26 which is the wireless IC chip for processing the radio signal received by the power feeding element 403, and the short-range wireless communication receiver 60 which is the wireless IC chip for processing the radio signal received by the power feeding element 407. In planar view of the annular base member 401 in the vertical direction, the GPS receiver 26 and the short-range wireless communication receiver 60 are respectively disposed inside the semicircular arc obtained by bisecting the annular base member 401.

In the power feeding elements, one power feeding element 403 whose received power is weaker than the received power of the other power feeding element is disposed within a range of 6 o'clock of the dial 11. According to the embodiment described herein, in the power feeding element 403, the power feeding unit 403a is disposed at a position of 6 o'clock of the dial 11, and receives the radio wave from the position information satellite. According to this configuration, when a wearer adopts a posture of lowering the arm wearing the wristwatch, the posture coincides with a direction in which a great antenna gain is obtained, thereby sufficiently achieving the receiving performance. The power feeding element 403 may be disposed in a range from 3 o'clock to 9 o'clock (6 o'clock side). Even in this case, compared to a case where the power feeding element 403 is disposed in a range from 9 o'clock to 3 o'clock (12 o'clock side), it is possible to improve the receiver sensitivity of the radio wave from the position information satellite.

Without being limited to the above-described embodiment, the invention can be modified as follows, for example. In addition, two or more modification examples described below can be appropriately combined with each other.

### MODIFICATION EXAMPLE 1

The ground plate 90 may be configured to include only the conduction pin 93 out of the conduction pin 93 and the conduction spring 90a. Conversely, the ground plate 90 may include only the conduction spring 90a.

### MODIFICATION EXAMPLE 2

Without being limited to four, the number of the conduction pins 93 or the conduction springs 90a may be one or more. The conduction pins 93 or the conduction springs 90a may not be disposed at an equal angel from the center C. The conduction spring 90a and the ground plate 90 may be a separate body, and the conduction spring 90a may be attached to the ground plate 90 by using a screw. A conduction spring as another member different from the ground plate 90 together with the shield plate 91 may be fixed to the lower surface side of the circuit board 25 by using the conduction pin 93. The ground plate 90 may be obtained by forming a conductive film on a front surface of an annular plate member formed of a non-conductive material.

### MODIFICATION EXAMPLE 3

In the antenna body 40 illustrated in FIG. 6A, without being limited to the endless O-shape, the passive element 402 may be formed in a C-shape which has a cutout portion, similarly to the power feeding element 403. That is, a shape of the passive element 402 may be annular or band-shaped. In this case, the antenna body 40 functions as a loop antenna having the C-shape as a whole. In the above-described embodiment, a case has been described where the length of the power feeding element 403 is set to resonate with the satellite signal. However, the length of the passive element 402 may be set to resonate with the satellite signal. In this case, the length of the power feeding element 403 is adjusted. In this manner, it is possible to easily adjust impedance between the antenna body 40 and a circuit (circuit block including the GPS receiver 26 or the short-range wireless communication receiver 60) electrically connected to the antenna body 40. The passive element is electromagnetically coupled to the power feeding element.

As described above, the passive element 402 is formed in the annular base member 401. However, the invention is not limited thereto. The passive element 402 may be formed on another member.

### MODIFICATION EXAMPLE 4

Instead of the power feeding pin 44, the joint 404 of the antenna body 40 may be electrically connected to the circuit board 25 so as to feed a predetermined potential by using a leaf spring, a lead wire, a coaxial cable, or a flexible substrate.

### MODIFICATION EXAMPLE 5

The second hand 13a may not be provided. The time display unit may employ a form in which the indicating hand 13 turns around on the dial 11 so as to indicate a time. In addition, for example, the time display unit may employ a form in which a liquid-crystal display panel having a display region having a size corresponding to the dial 11 is provided so as to display a time by displaying the dial 11 or an image of the indicating hand 13 on the display region.

### MODIFICATION EXAMPLE 6

The antenna body 40(base member 401) and the ground plate 90 may not be necessarily disposed so that the center axes coincide with each other. In brief, in planar view of the electronic timepiece 100 (in planar view of the base member 401 and the ground plate 90 in the direction of the annular center axis), both of these may be disposed so that the opening portion 406 of the base member 401 and at least a portion of the opening portion of the ground plate 90 overlap each other. The spaced distance Ad between the antenna body 40 (base member 401) and the ground plate 90 may be equal to or shorter than a distance which enables resonance between the ground plate 90 and the power feeding element 403.

### MODIFICATION EXAMPLE 7

In the above-described embodiment, for example, a case has been described where a side surface of the exterior case is configured to include the case body 80 and the glass edge 81. However, the side surface of the exterior case may be configured to include one member formed of a non-conductive material such as ceramic and plastic. Another charging method in addition to solar charging may be employed. For example, a charging coil may be provided so that the electronic timepiece can be charged with power supplied from an exterior charger by means of electromagnetic induction. Instead of the secondary battery 27, a primary battery such as a lithium battery may also be used.

### MODIFICATION EXAMPLE 8

Instead of GPS, a global navigation satellite system (GNNS) such as Galileo (EU), GLONASS (Russia), North Star (China), and IRNSS (India) maybe utilized. A satellite-based augmentation system (SBAS) or a quasi-zenith satellite system (QZSS) may also be utilized. In this way, the arm-wearable device according to the invention may receive a radio wave from another satellite in addition to the GPS satellite 20 so as to correct the internal time. Without being limited to the radio wave from a satellite, for example, the arm-wearable device according to the invention may be an electronic timepiece which receives a radio wave of 900 MHz band for RFID tag.

### MODIFICATION EXAMPLE 9

Without being limited to the wristwatch, the arm-wearable device according to the invention may be a pocket timepiece or a table timepiece. The invention may be applied to various electronic devices having an electronic timepiece function (for example, a mobile phone or a digital camera).

### MODIFICATION EXAMPLE 10

In the above-described embodiment, as the two power feeding elements, the power feeding element for GPS and the power feeding element for short-range wireless communication are employed. However, the invention is not limited thereto. Other wireless communication antennas (for example, sub-gigahertz band of 900 MHz band or NFC (short-range wireless communication)) may be employed in combination therewith.

The entire disclosure of Japanese Patent Application No. 2016-000246, filed Jan. 4, 2016 is expressly incorporated by reference herein.

What is claimed is:

1. An arm-wearable device comprising:
an exterior case;
a time display unit that is accommodated in the exterior case, and that displays a time; and
an annular antenna body that is disposed around the time display unit,
wherein the antenna body has an annular base member having a dielectric body, a first band-shaped power feeding element which is disposed in the base member, which is electrically conductive, and to which a predetermined potential is fed from a first power feeding unit, and a second band-shaped power feeding element which is disposed in the base member, which is electrically conductive, and to which a predetermined potential is fed from a second power feeding unit.

2. The arm-wearable device according to claim 1,
wherein, in planar view of the annular base member in a vertical direction, the first power feeding element and the second power feeding element are disposed at a position where both of these do not overlap each other.

3. The arm-wearable device according to claim 1,
wherein an annular or a band-shaped passive element which is electrically conductive is disposed in the base member, apart from the first power feeding element and the second power feeding element.

4. The arm-wearable device according to claim 1,
wherein, in planar view of the annular base member in a vertical direction, the first power feeding unit is disposed inside a region of the first power feeding element, the second power feeding unit is disposed inside a region of the second power feeding element, and the first power feeding element and the second power feeding element are disposed at a position where both of these do not overlap each other.

5. The arm-wearable device according to claim 1, further comprising:
a first wireless IC chip that processes a radio signal received by the first power feeding element; and
a second wireless IC chip that processes a radio signal received by the second power feeding element,
wherein, in planar view of the annular base member in a vertical direction, the first wireless IC chip and the second wireless IC chip are respectively disposed inside a semicircular arc obtained by bisecting the annular base member.

6. The arm-wearable device according to claim 1,
wherein the first power feeding unit or the second power feeding unit is disposed within a range from 3 o'clock to 9 o'clock of the time display unit, and receives a radio wave from a position information satellite.

7. The arm-wearable device according to claim 1,
wherein either the first power feeding element or the second power feeding element whose received power is weaker than received power of the other power feeding element is disposed within a range from 3 o'clock to 9 o'clock of the time display unit.

8. An antenna body comprising:
an annular base member that has a dielectric body;
a first band-shaped power feeding element that is disposed in the base member, that is electrically conductive, and to which a predetermined potential is fed from the outside; and
a second band-shaped power feeding element that is disposed in the base member, that is electrically conductive, and to which a predetermined potential is fed from the outside.

9. The antenna body according to claim 8,
wherein, in planar view of the annular base member in a vertical direction, the first power feeding element and the second power feeding element are disposed at a position where both of these do not overlap each other.

10. The antenna body according to claim 8,
wherein an annular or a band-shaped passive element which is electrically conductive is disposed in the base member, apart from the first power feeding element and the second power feeding element.

11. The antenna body according to claim 8,
wherein, in planar view of the annular base member in a vertical direction, a first power feeding unit for feeding power to the first power feeding element is disposed inside a region of the first power feeding element, a second power feeding unit for feeding power to the second power feeding element is disposed inside a region of the second power feeding element, and the first power feeding element and the second power feeding element are disposed at a position where both of these do not overlap each other.

12. The antenna body according to claim 8, further comprising:
a first wireless IC chip that processes a radio signal received by the first power feeding element; and
a second wireless IC chip that processes a radio signal received by the second power feeding element,
wherein, in planar view of the annular base member in a vertical direction, the first wireless IC chip and the second wireless IC chip are respectively disposed inside a semicircular arc obtained by bisecting the annular base member.

13. The antenna body according to claim 11,
wherein in a case where the antenna body is accommodated in an exterior case of a timepiece, either the first power feeding unit or the second power feeding unit is disposed at a position corresponding to a range from 3 o'clock to 9 o'clock of the time display unit, and receives a radio wave from a position information satellite.

14. The antenna body according to claim 8,
wherein in a case where the antenna body is accommodated in an exterior case of a timepiece, either the first power feeding element or the second power feeding element whose received power is weaker than received power of the other power feeding element is disposed at a position corresponding to a range from 3 o'clock to 9 o'clock of the time display unit.
